(19) United States
(12) Patent Application Publication
(10) Pub. No.: US 2023/0071642 A1
(43) Pub. Date: Mar. 9, 2023

(54) Lens Device

(71) Applicants: Sintai Optical (Shenzhen) Co., Ltd., ShenZhen City (CN); Asia Optical Co., Inc., Taichung (TW)

(72) Inventor: Guo-Quan LIN, ShenZhen City (CN)

(21) Appl. No.: 17/899,774

(22) Filed: Aug. 31, 2022

(30) Foreign Application Priority Data
Sep. 9, 2021 (CN) 202111054605.5
Jun. 15, 2022 (CN) 202210671948.4

(51) Int. Cl. G02B 13/00; G02B 9/14; G02B 7/02

(52) U.S. Cl. CPC G02B 13/0065; G02B 9/14; G02B 7/021

(57) ABSTRACT

A lens device includes at least one frame, at least one lens, at least one optical element and an image forming assembly. The lens is disposed in the frame and has an optical axis extending in a first direction. The optical element includes at least one non-planar surface. The light coming from an object side propagates through the lens and the non-planar surface to the image forming assembly. The lens is obtained from cutting an upper portion and a lower portion of a circular lens along planes in parallel to the first direction and a second direction.

### BACKGROUND OF THE INVENTION

### Field of the Invention

The invention relates to an optical field and in particular relates to a lens device.

### Description of the Related Art

FIG. 1A is a schematic view showing the structure of a lens device of the prior art. FIG. 1B is a front view of the lens device of FIG. 1A. FIG. 1C is a modulation transfer function (MTF) diagram of the lens device of FIG. 1A. As shown in FIGS. 1A-1C, the lens device 1 of the prior art includes a frame 11 and a lens 12 disposed in the frame 11. Both of the inner circumferential surface of the frame 11 and the outer circumferential surface of the lens 12 have circular sections, when sectioned in a direction perpendicular to an optical axis. For such a lens device, points A and B in FIG. 3 that respectively indicate the locations of peak values of the modulation transfer function in a horizontal direction H and in a vertical direction V are close to or coincide with each other. When photos are taken, the photographed scene can be clear in both horizontal direction and vertical direction.

FIG. 2A is a schematic view showing the structure of some elements of another lens device of the prior art. FIG. 2B is a front view of some elements of the lens device of FIG. 2A. FIG. 2C depicts the light paths of the lens device of FIG. 2A. FIG. 2D is a modulation transfer function diagram of the lens device of FIG. 2A. FIGS. 2E and 2F are photos taken by using the lens device of FIG. 2A in a test process. As shown in FIGS. 2A-2F, the lens device 2 includes a frame 21, a lens 22 disposed in the frame 21, and a reflective mirror 23 configured to reflect light coming from the lens 22. The reflective mirror 23 is a plane mirror.

In order to match a portable electronic device that has a limited thickness, the lens device 2 needs to have a reduced volume, especially when the lens device 2 is a telephoto lens that has long rear focal length and large diameter. In order to reduce the volume of the lens device 2, the edges of the lens 22 are cut. Also, the structure of the frame 21 is necessarily modified to match that of the lens 22.

Because of cutting the edges of the lens 22, the shape of the lens 22 is not symmetrical in the horizontal direction and in the vertical direction. As a result, the locations of peak values of the module transfer function in the horizontal direction and in the vertical direction are staggered. That is, the location (indicated by point A) of the peak value of the module transfer function in the horizontal direction and the location (indicated by point B) of the peak value of the module transfer function in the vertical direction are separated from each other as shown in FIG. 1C. Thus, when light passes through the lens 22 and is reflected by the reflective mirror 23 to form an image, the formed image fails to be simultaneously clear in the horizontal direction and in the vertical direction as shown in FIGS. 2E and 2F. That negatively affects the quality of the images formed by the lens device 2.

### BRIEF SUMMARY OF THE INVENTION

The invention provides a solution to address the described drawbacks. The flexible printed circuit board of the lens device of the invention has improved bending-resistance ability.

The lens device in accordance with an exemplary embodiment of the invention includes at least one frame, at least one lens, at least one optical element and an image forming assembly. The lens is disposed in the frame and has an optical axis extending in a first direction. The optical element includes at least one non-planar surface. Light coming from an object side propagates through the lens and the non-planar surface to the image forming assembly. The lens is obtained from cutting an upper portion and a lower portion of a circular lens along planes in parallel to the first direction and a second direction.

In another exemplary embodiment, the first direction is perpendicular to the second direction, and the non-planar surface at least has a curved section when sectioned along a plane in parallel to both of the first direction and the second direction.

In yet another exemplary embodiment, the non-planar surface is a cylindrical reflective surface or a spherical surface. The non-planar surface is bent towards or away from the lens. A central axis of the cylindrical reflective surface is disposed at a side of the cylindrical reflective surface that is close to the lens or distant from the lens. The central axis is extended in a third direction. A spherical center of the spherical reflective surface is disposed at a side of the spherical reflective surface that is close to the lens or distant from the lens. The firs direction, the second direction and the third direction are perpendicular to each other.

In another exemplary embodiment, a volume of the lens and a diameter of the cylindrical reflective surface have a positive correlation.

In yet another exemplary embodiment, the lens includes an outer circumferential surface. The outer circumferential surface includes first outer circumferential portions and second outer circumferential portions. The first outer circumferential portions are disposed opposite to each other in the second direction. The second outer circumferential portions are connected between the first outer circumferential portions and disposed opposite to each other in a third direction. The first direction, the second direction and the third direction are perpendicular to each other. The frame includes an inner circumferential surface matching the outer circumferential surface in shape. The inner circumferential surface includes first inner circumferential portions and second inner circumferential portions. The first inner circumferential portions are disposed opposite to each other in the second direction. The second inner circumferential portions are connected between the first inner circumferential portions and disposed opposite to each other in the third direction. The first outer circumferential portions and the first inner circumferential portions are curved. The second outer circumferential portions and the second inner circumferential portions are straight.

In another exemplary embodiment, the lens device further includes at least one ring spacer and light shield. The lens device includes a plurality of lenses among which there is a lens disposed closest to an object side. The ring spacer is disposed between two adjacent lenses. The light shield is disposed between the object side and the lens disposed closest to the object side, or between two adjacent lenses. The ring spacer is obtained from cutting an upper portion and a lower portion of a circular ring spacer. The light shield is obtained from cutting an upper portion and a lower portion of a circular light shield.

In yet another exemplary embodiment, the frame further includes third outer circumferential portions and fourth outer circumferential portions. The third outer circumferential portions are disposed opposite to each other in the second direction. The fourth outer circumferential portions are connected between the third outer circumferential portions and disposed opposite to each other in a third direction. The third outer circumferential portions are provided with a plurality of strip structures.

In another exemplary embodiment, the frame further includes a pair of concave portions and convex portions, the concave portions are disposed at an end of the frame near an object side, and the convex portions are formed next to the concave portions.

In yet another exemplary embodiment, the non-planar surface is curved either inwards or outwards.

In another exemplary embodiment, the frame defines an adhesive-applying groove. The adhesive-applying groove is penetrated through the frame and corresponded to the second outer circumferential portions. The adhesive-applying groove is elongated.

In yet another exemplary embodiment, the frame defines an adhesive-applying groove. The adhesive-applying groove is penetrated through the frame and is corresponded to the second outer circumferential portions. An outline of the second outer circumferential portion of the lens is obtained from a projection onto the frame in the third direction, and a shape of the adhesive-applying groove is similar to the outline of the second outer circumferential portion. The adhesive-applying groove is smaller than the lens when observed in the third direction. The frame includes a reinforcing sheet fitting the adhesive-applying groove.

In another exemplary embodiment, the optical element includes a first reflective surface and a second reflective surface. The first reflective surface reflects the light to propagate in the second direction after the light is emitted from the lens. The second reflective surface reflects the light along the first direction to the image forming assembly after the light is reflected on the first reflective surface. At least one of the first reflective surface and the second reflective surface includes the non-planar surface.

In yet another exemplary embodiment, the lens device includes a plurality of lenses among which there are a lens disposed closest to an object side and another lens disposed closest to the image forming assembly. The optical element is one or more following elements: a light path turning unit disposed between the object side and the lens disposed closest to the object side, a reflective assembly disposed between the object side and the lens disposed closest to the object side, a light path turning unit disposed between two adjacent lenses, a reflective assembly disposed between two adjacent lenses, and an optical filter disposed between the image forming assembly and the lens closest to the image forming assembly. The reflective assembly includes a first reflective surface. The light path turning unit includes a light path turning surface, a light incident surface and a light emitting surface. The optical filter includes a surface. At least one of the first reflective surface, the light path turning surface, the light incident surface, the light emitting surface and the surface is non-planar. The light experiences at least two reflections before reaching the image forming assembly. The non-planar surface is configured to compensate for separation of peak values of modulation transfer function of the lens.

In another exemplary embodiment, the lens device further includes an additional lens fixed onto the optical element, wherein the lens device includes one or more lenses that are stationary or movable along the optical axis.

In yet another exemplary embodiment, the curved section is in shape of a part of circle and the non-planar surface is a reflective surface and satisfies a condition of 4000 mm<R<5000 mm.

In another exemplary embodiment, the reflective assembly further includes a first reflective part and a second reflective part. The first reflective part includes the first reflective surface, a first back surface disposed opposite to the first reflective surface, and plurality of first cut edges connecting the first reflective surface and the first back surface. The second reflective part includes a second reflective surface, a second back surface disposed opposite to the second reflective surface, and plurality of second cut edges connecting the second reflective surface and the second back surface.

In yet another exemplary embodiment, the non-planar surface is a cylindrical reflective surface or a spherical reflective surface. For a conventional lens device that operates with the spherical reflective surface, a difference between peak values is 10 μm+5% when curvature of the spherical reflective surface is ranged from 15.5×1000 to 18.5×1000, a difference between peak values is 20 μm+5% when curvature of the spherical reflective surface is ranged from 8.5×1000 to 11.5×1000, and a difference between peak values is 30 μm±5% when curvature of the spherical reflective surface is ranged from 5.1×1000 to 8.1×1000. For the conventional lens device that operates with the cylindrical reflective surface, a difference between peak values is 10 μm±5% when curvature of the cylindrical reflective surface is ranged from 34.5×1000 to 37.5×1000, a difference between peak values is 20 μm±5% when curvature of the cylindrical reflective surface is ranged from 18.5×1000 to 21.5×1000, and a difference between peak values is 30 μm+5% when curvature of the cylindrical reflective surface is ranged from 11.5×1000 to 14.5×1000.

In another exemplary embodiment, for the conventional lens device that operates with the spherical reflective surface, the difference between the peak values is 10 μm when the curvature of the spherical surface is 17000, the difference between the peak values is 20 μm when the curvature of the spherical surface is 10000, and the difference between the peak values is 30 μm when the curvature of the spherical surface is 6600. For the conventional lens device that operates with the cylindrical reflective surface, the difference between the peak values is 10 μm when the curvature of the cylindrical surface is 36000, the difference between the peak values is 20 μm when the curvature of the cylindrical surface is 20000, and the difference between the peak values is 30 μm when the curvature of the cylindrical surface is 13000.

In yet another exemplary embodiment, the lens further includes a first lens, a second lens and a third lens arranged from the object side to an image side. The first lens is a concave-convex lens with positive refractive power. The second lens is a biconcave lens negative refractive power. The third lens is a biconvex lens with positive refractive power.

In another exemplary embodiment, the lens is a non-circular lens, the light propagates through the non-circular lens and the non-planar surface to the image forming assembly, and the non-planar surface is a cylindrical reflective surface or a spherical reflective surface.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1A is a schematic view showing the structure of a lens device of the prior art.

FIG. 1B is a front view of the lens device of FIG. 1A.

FIG. 1C is a modulation transfer function diagram of the lens device of FIG. 1A.

FIG. 2A is a schematic view showing the structure of some elements of another lens device of the prior art.

FIG. 2B is a front view of some elements of the lens device of FIG. 2A.

FIG. 2C depicts the light paths of the lens device of FIG. 2A.

FIG. 2D is a modulation transfer function diagram of the lens device of FIG. 2A.

FIGS. 2E and 2F are photos taken by using the lens device of FIG. 2A in a test process.

FIG. 3A is a schematic view showing the structure of a lens device in accordance with a first embodiment of the invention.

FIG. 3B is another schematic view of the lens device in accordance with the first embodiment of the invention.

FIG. 3C is a schematic view showing some elements of the lens device in accordance with the first embodiment of the invention.

FIG. 3D is another schematic view showing an element of the lens device in accordance with the first embodiment of the invention.

FIG. 3E is another schematic view showing the structure of an element of the lens device in accordance with the first embodiment of the invention,

FIG. 4 is a schematic view showing the structure of a lens device in accordance with a second embodiment of the invention.

FIGS. 5A, 5B and 5C respectively depict the difference between the peak values of the modulation transfer function for different curvatures when a conventional lens device operates with a spherical reflective surface.

FIGS. 5D, 5E and 5F respectively depict the difference between the peak values of the modulation transfer function for different curvatures when a conventional lens device operates with a cylindrical reflective surface.

FIG. 6 is a modulation transfer function diagram of the lens device in accordance with the invention.

FIG. 7 is a schematic diagram showing a picture photographed by the lens device during the testing process in accordance with the invention.

FIG. 8A is a schematic view showing the structure of a lens device in accordance with a third embodiment of the invention.

FIG. 8B is another schematic view showing the structure of a lens device in accordance with a third embodiment of the invention.

FIG. 9A is a schematic view showing the structure of a lens device in accordance with a fourth embodiment of the invention.

FIG. 9B is another schematic view showing the structure of a lens device in accordance with the fourth embodiment of the invention.

FIG. 9C is a schematic view of the light-path turning unit of the lens device in accordance with the fourth embodiment of the invention.

FIG. 9D is another schematic view of the light-path turning unit of the lens device in accordance with the fourth embodiment of the invention.

FIG. 10 is a schematic view showing the structure of a lens device in accordance with a fifth embodiment of the invention.

FIG. 11 is a schematic view showing some elements of the lens device in accordance with the sixth embodiment of the invention.

FIG. 12A is a schematic view of some elements of a lens device in accordance with a seventh embodiment of the invention.

FIG. 12B is a schematic view of the elements of FIG. 12A in the zooming state.

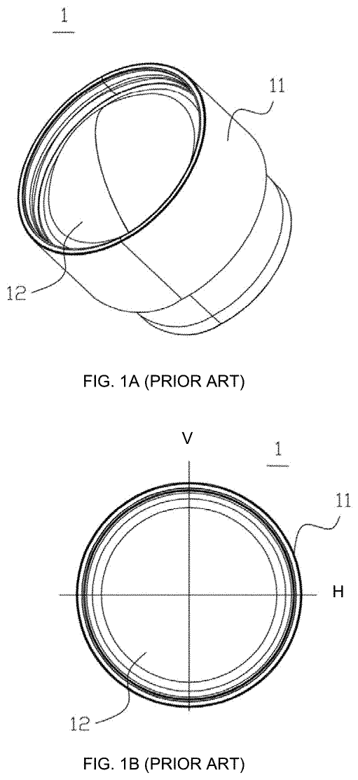

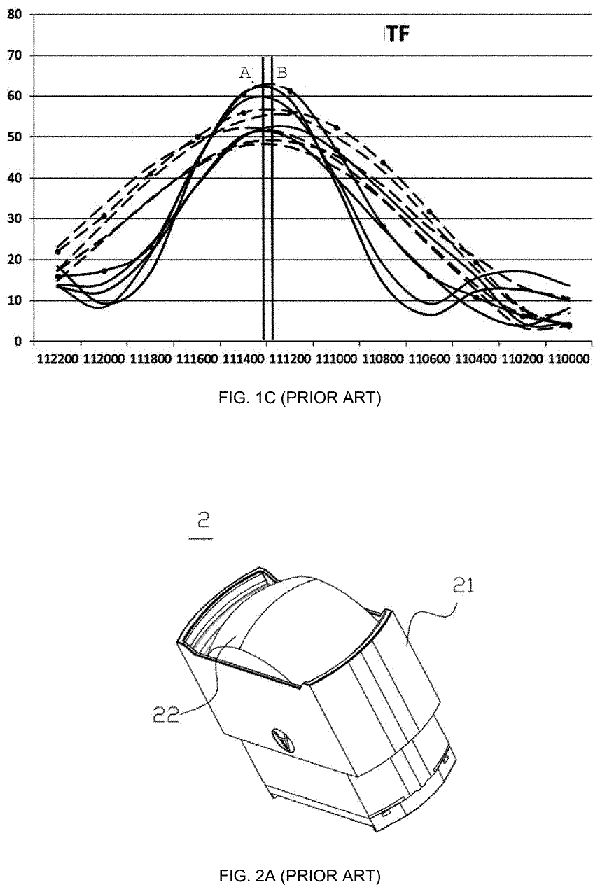

### DETAILED DESCRIPTION OF THE INVENTION

The purpose, technical scheme and merits of the invention can be more fully understood by reading the subsequent detailed description and embodiments with references made to the accompanying drawings. However, it is understood that the subsequent detailed description and embodiments are only used for describing the invention. The invention is not limited thereto.

As described, the image formed by the edge-cut lens device fails to be simultaneously clear in the horizontal direction and in the vertical direction. To address the problem, the invention provides a method of adjusting the location of the peak value of modulation transfer function, wherein a non-planar optical element is used to eliminate or reduce the difference between the peak values of the module transfer function in different directions (e.g. in the horizontal direction and in the vertical direction). The optical element may be a reflective assembly, a light path turning unit or an optical filter. The lens device of the invention is described in detail below.

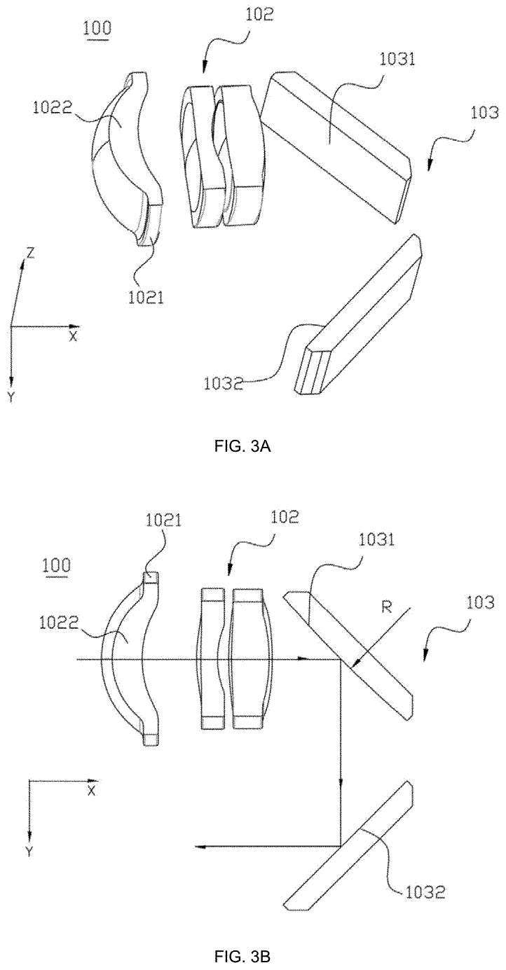

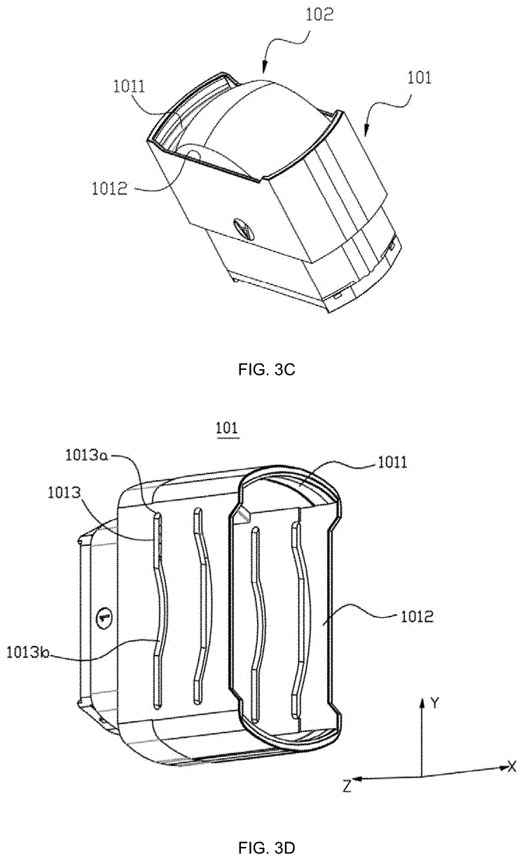

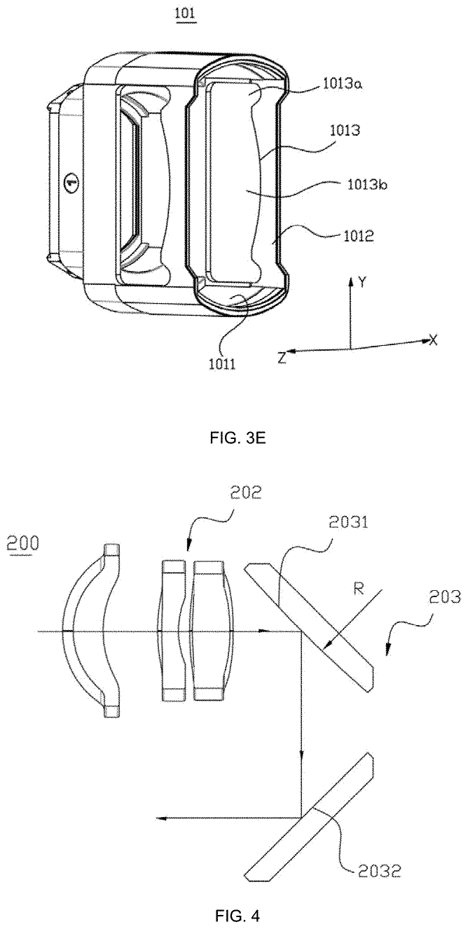

FIG. 3A is a schematic view showing the structure of a lens device 100 in accordance with a first embodiment of the invention. FIG. 3B is another schematic view of the lens device 100 in accordance with the first embodiment of the invention. FIG. 3C is a schematic view showing some elements of the lens device 100 in accordance with the first embodiment of the invention. As shown in FIGS. 3A-3C, the lens device 100 includes a frame 101, one or more lenses 102 disposed in the frame 101, a reflective assembly 103 and an image forming assembly (not shown). The lenses 102 have an optical axis extending in a first direction X. The lens device 100 may include more than one frame 101, and one or more lenses 102 corresponding to each frame 101, wherein all the frames are kept stationary, or at least one frame is stationary and the other frames are movable along the optical axis to perform zooming operation.

The reflective assembly 103 includes a first reflective surface 1031 and a second reflective surface 1032. Light passing through the lens 102 is reflected on the first reflective surface 1031 to propagate in a second direction Y. The light coming from the first reflective surface 1031 is reflected on the second reflective surface 1032 to propagate in the first direction X and reaches the image forming assembly. The second direction Y may be perpendicular to the first direction X. However, the invention is not limited thereto. The first reflective surface 1031 is disposed opposite to the second reflective surface 1032. The first reflective surface 1031 and the second reflective surface 1032 may have an included angle therebetween, for example, ninety degrees. The second reflective surface 1032 and the first reflective surface 1031 can be properly arranged to reduce the volume of the lens device 100. However, the invention is not limited thereto. The second reflective surface 1032 is not necessary. The reflective assembly 103 can include only the first reflective surface 1031.

Further, the reflective assembly 103 includes a first reflective part and a second reflective part. The first reflective part includes a first reflective surface 1031, a first back surface disposed opposite to the first reflective surface 1031, and a plurality of cut edges connecting the first reflective surface 1031 and the first back surface. The second reflective part includes a second reflective surface 1032, a second back surface disposed opposite to the second reflective surface 1032, and a plurality of cut edges connecting the second reflective surface 1032 and the second back surface. By means of the cut edges, alignment of the reflective assembly 103 for assembling the lens device 100 becomes easier and the reflective assembly 103 mounted in the lens device 100 becomes more stable.

In order to match an electronic device that has a limited thickness, the lens 102 is obtained by cutting away the upper portion and the lower portion of a circular lens along planes in parallel to the first direction X and the second direction Y.

The outer circumferential surface of the lens 102 includes first outer circumferential portions 1021 and second outer circumferential portions 1022. The first outer circumferential portions 1021 are disposed opposite to each other in the second direction Y. The second outer circumferential portions 1022 are connected between the first outer circumferential portions 1021 and disposed opposite to each other in a third direction Z. The third direction Z may be perpendicular to the first direction X and the second direction Y. The inner surfaces of the frame 101 matches the outer circumferential surfaces of the lens 102 in shape. The inner surface of the frame 101 includes first inner circumferential portions 1011 and second inner circumferential portions 1012. The first inner circumferential portions 1011 are disposed opposite to each other in the second direction Y. The second inner circumferential portions 1012 are connected between the first inner circumferential portions 1011 and disposed opposite to each other in the third direction Z. The first outer circumferential portions 1021 and the first inner circumferential portions 1011 may be curved, for instance, in shape of a part of circular circumference. The second outer circumferential portions 1022 and the second inner circumferential portions 1012 may be straight. That is, they are disposed in parallel and symmetrically.

The first outer circumferential portions 1021 of the lens 102 fit the first inner circumferential portions 1011 of the frame 101 with interference. By such arrangement, the lens 102 is fixed to the interior of the frame 101.

After passing through the lens 102, the light propagates in the first direction X, reaches the first reflective surface 1031, and is reflected on the first reflective surface 1031 to propagate in the second direction Y. In this embodiment, the first reflective surface 1031 is a spherical reflective surface and is bent away from the lens 102. Therefore, the spherical center of the first reflective surface 1031 is disposed at the side distant from the lens 102. For the lens 102, the spherical reflective surface is provided with a large diameter so as to be close to a plane in shape. When the volume of the lens 102 is small, the spherical reflective surface correspondingly has a small diameter. When the volume of the lens 102 is large, the spherical reflective surface correspondingly has a large diameter. In other words, the volume of the lens 102 and the diameter of the spherical reflective surface have a positive correlation. Preferably, the radius R of the reflective surface satisfies: 4000 mm<R<5000 mm.

The light, coming from the first reflective surface 1031 by reflection, is reflected on the second reflective surface 1032, propagates in the first direction X, and reaches the image forming assembly. Therefore, the image forming assembly can be disposed at a side of the lens in the second direction Y to reduce the entire volume of the lens device 100. Further, before reaching the image forming assembly, the light coming from the object side experiences two reflections in total, i.e. a reflection on the first reflective surface 1031 and a reflection on the second reflective surface 1032.

The frame 101 further includes third outer circumferential portions and fourth outer circumferential portions. The third outer circumferential portions are disposed opposite to each other in the second direction Y. The fourth outer circumferential portions are connected between the third outer circumferential portions and disposed opposite to each other in a third direction Z. The third outer circumferential portions are provided with a plurality of strip structures, whereby alignment of the frame 101 with other elements for assembling the lens device 100 becomes easier and the frame 101 mounted in the lens device 100 is stabilized. The frame 101 further includes a pair of concave portions disposed at the end near the object side to maximize the light quantity into the lens device 100 and to achieve miniaturization of the lens device. The convex portions correspondingly formed next to the concave portions are able to block undesirable light.

FIG. 3D is another schematic view showing an element of the lens device 100 in accordance with the first embodiment of the invention. As shown in FIG. 3D, the frame 101 has an adhesive-applying groove 1013. The adhesive-applying groove 1013 is penetrated from the outer surface of the frame 101 to the second inner circumferential portion 1012, thereby being corresponded to the second outer circumferential portion 1022 of the lens 102. The adhesive-applying groove 1013 extending on the second inner circumferential portion 1012 may be in shape of straight line, curved line or polyline. However, the invention is not limited thereto. In this embodiment depicted by figures, the adhesive-applying groove 1013 is elongated and therefore includes an end portion 1013a corresponding to the edge portion of the lens 102 and a curved portion 1013b corresponding to the central effective-diameter portion of the lens 102. The end portion 1013a may be in shape of straight line. The concaveness and/or convexness of the curved portion 1013b may be consistent with those of the surface of the lens 102. The number of the adhesive-applying groove 1013 may be plural.

In assembly, the lens 102 is fitted into the frame 101 and adhesive is applied to the adhesive-applying groove 1013. After adhesive is cured, the lens 102 is fixed. The invention differs from the prior art in that adhesive is applied at the exterior of the frame 101 so that the adhesive-applying operation is convenient and overflowing of adhesive can be avoided. Further, use of the adhesive can guarantee the reliability of connection between the lens 102 and the frame 101, without requirements of much interference therebetween. Therefore, the force applied to the lens 102 by the frame 101 can be reduced. Further, a firm connection between the lens 102 and the frame 101 can maintain good strength and reliability of the lens 102, even during the test of reliability or under the conditions of high temperature and high humidity.

FIG. 3E is another schematic view showing the structure of an element of the lens device 100 in accordance with the first embodiment of the invention, wherein the part same as that of the previous embodiment will not be described again.

The second inner circumferential portion 1012 of the adhesive-applying groove 1013 is similar to the second outer circumferential portion of the lens 102 in shape. The adhesive-applying groove 1013 is smaller than the second outer circumferential portion of the lens 102. This embodiment differs from the previous embodiment in that the shape of the adhesive-applying groove 1013 is changed. In this embodiment, the adhesive-applying groove 1013 is not elongated. Rather, the shape of the adhesive-applying groove 1013 is similar to the outline of the outer circumferential surface of the lens 102 obtained from a projection onto the frame 101 in the third direction Z, and the adhesive-applying groove 1013 is smaller than the lens 102 when observed in the third direction Z. The adhesive-applying groove 1013 includes an end portion 1012a corresponding to the edge portion of the lens 102, and a curved portion 1012b corresponding to the central effective-diameter portion of the lens 102.

In this embodiment, the term “similar” means “geometrically similar” in math. That is, the shapes are the same but dimensions are different. However, the invention is not limited thereto. The shape of the adhesive-applying groove 1013 may not be similar to the outline of the outer circumferential surface of the lens 102 obtained from a projection onto the frame 101 in the third direction Z. For example, the adhesive-applying groove 1013 may be rectangular, oval, or in other irregular shapes.

The frame 101 may further include a reinforcing sheet (not shown) that fits the adhesive-applying groove 1013. The reinforcing sheet is similar to the adhesive-applying groove 1013 in shape and may be slightly smaller than the adhesive-applying groove 1013. The reinforcing sheet is fixed to the interior of the adhesive-applying groove 1013 by adhesive.

The lens 102 and the frame 101 may be integrally formed into one piece, especially when the lens 102 is made of plastic. This arrangement can effectively promote the strength of the lens 102 so that the lens 102 can maintain its performance, even during the test of reliability or under the conditions of high temperature and high humidity.

FIG. 4 is a schematic view showing the structure of a lens device 200 in accordance with a second embodiment of the invention. The lens device 200 includes a frame 201, one or more lenses 202 disposed in the frame 201, a reflective assembly 203 and an image forming assembly (not shown). The reflective assembly 203 includes a first reflective surface 2031 and a second reflective surface 2032. Light passing through the lens 202 is reflected on the first reflective surface 2031 to propagate in the second direction Y. The light coming from the first reflective surface 2031 is reflected on the second reflective surface 2032 to propagate in the first direction X and reaches the image forming assembly. Accordingly, the reflective assembly 203 provides two reflections in total. This embodiment has a part same as that of the first embodiment, and the same part will not be described again.

The second embodiment differs from the first embodiment in that the first reflective surface 2031 is a cylindrical reflective surface and is bent away from the lens 202. Therefore, the central axis of the first reflective surface 2031 is disposed at the side thereof distant from the lens 202 and is extended in the third direction Z. The third direction Z may be perpendicular to the first direction X and the second direction Y. For the lens 202, the cylindrical reflective surface is provided with a large diameter so as to be close to a plane in shape. When the volume of the lens 202 is small, the cylindrical reflective surface correspondingly has a small diameter. When the volume of the lens 202 is large, the cylindrical reflective surface correspondingly has a large diameter. In other words, the volume of the lens 202 and the diameter of the cylindrical reflective surface have positive correlation.

Although described in the first embodiment and the second embodiment, the shape of the first reflective surface of the invention is not limited to being spherical and cylindrical. The first reflective surface may be a curved surface, a non-planar surface, or in other shapes. Preferably, the first reflective surface at least has a portion that is a part of a circular when sectioned along a plane in parallel to both of the first direction X and the second direction Y. The first reflective surface may be curved in a direction away from the lens or in an opposite direction toward the lens. That is, the first reflective surface may be curved either inwards or outwards. As described, the first reflective surface at least has a portion that is a part of a circular when sectioned along a plane XY. Therefore, the first reflective surface may be a combination of a part of a spherical surface and a part of cylindrical surface, or in other shapes.

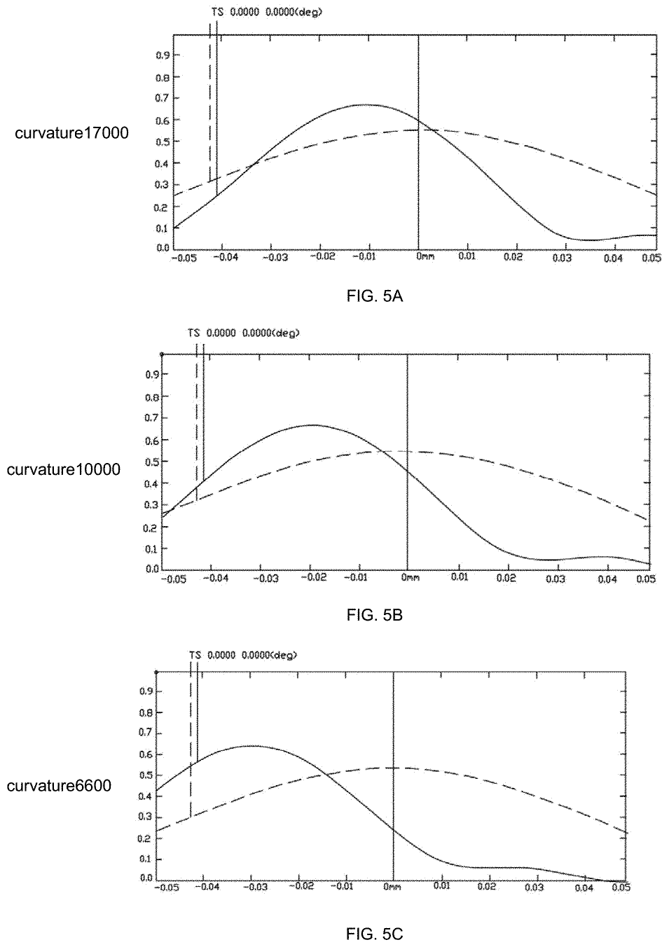

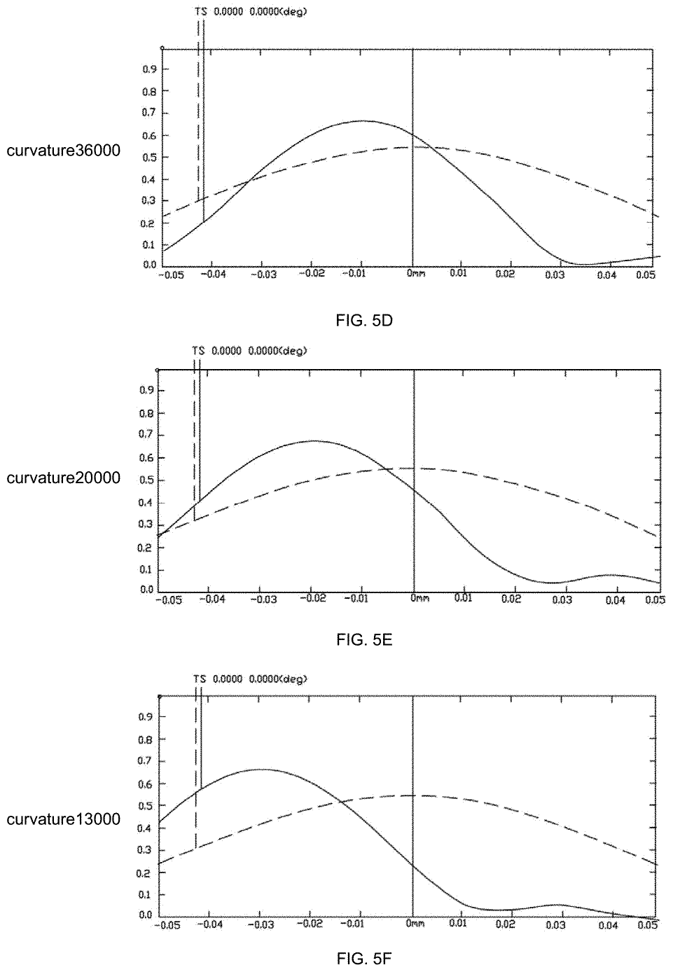

FIGS. 5A, 5B and 5C respectively depict the difference between the peak values of the modulation transfer function for different curvatures when a conventional lens device operates with a spherical reflective surface. FIGS. 5D, 5E and 5F respectively depict the difference between the peak values of the modulation transfer function for different curvatures when a conventional lens device operates with a cylindrical reflective surface. As shown in FIGS. 5A-5F, the peak values of the modulation transfer function of a lens device in the horizontal direction (i.e. the second direction Y) and in the vertical direction (i.e. the third direction Z) are not equal, when a conventional lens device (i.e. the lens is circular) is provided with a reflective surface of the invention. The curvature of the first reflective surface is taken as an example for descriptions in detail wherein the first reflective surface is sectioned by a plane in parallel to the first direction X and the second direction Y. For a conventional lens device that operates with a spherical reflective surface, the difference between the peak values is 10 μm±5% when the curvature of the spherical surface is ranged from 15500 (=15.5×1000) to 18500 (=18.5×1000), the difference between the peak values is 20 μm±5% when the curvature of the spherical surface is ranged from 8500 (=8.5×1000) to 11500 (=11.5×1000), and the difference between the peak values is 30 μm+5% when the curvature of the spherical surface is ranged from 5100 (=5.1×1000) to 8100 (=8.1×1000). For a conventional lens device that operates with a cylindrical reflective surface, the difference between the peak values is 10 μm+5% when the curvature of the cylindrical surface is ranged from 34500 (=34.5×1000) to 37500 (=37.5×1000), the difference between the peak values is 20 μm+5% when the curvature of the cylindrical surface is ranged from 18500 (=18.5×1000) to 21500 (=21.5×1000), and the difference between the peak values is 30 μm±5% when the curvature of the cylindrical surface is ranged from 115000 (=11.5×1000) to 14500 (=14.5×1000). More specifically, for a conventional lens device that operates with a spherical reflective surface, the difference between the peak values is 10 μm when the curvature of the spherical surface is 17000, the difference between the peak values is 20 μm when the curvature of the spherical surface is 10000, and the difference between the peak values is 30 μm when the curvature of the spherical surface is 6600. For a conventional lens device that operates with a cylindrical reflective surface, the difference between the peak values is 10 μm when the curvature of the cylindrical surface is 36000, the difference between the peak values is 20 μm when the curvature of the cylindrical surface is 20000, and the difference between the peak values is 30 μm when the curvature of the cylindrical surface is 13000.

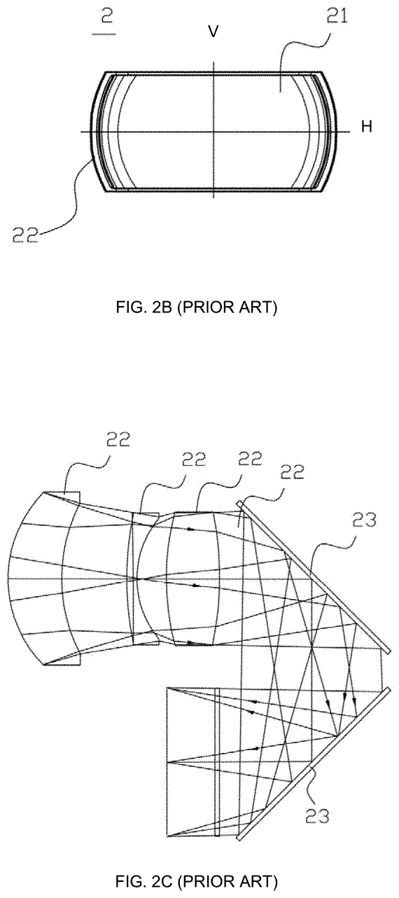

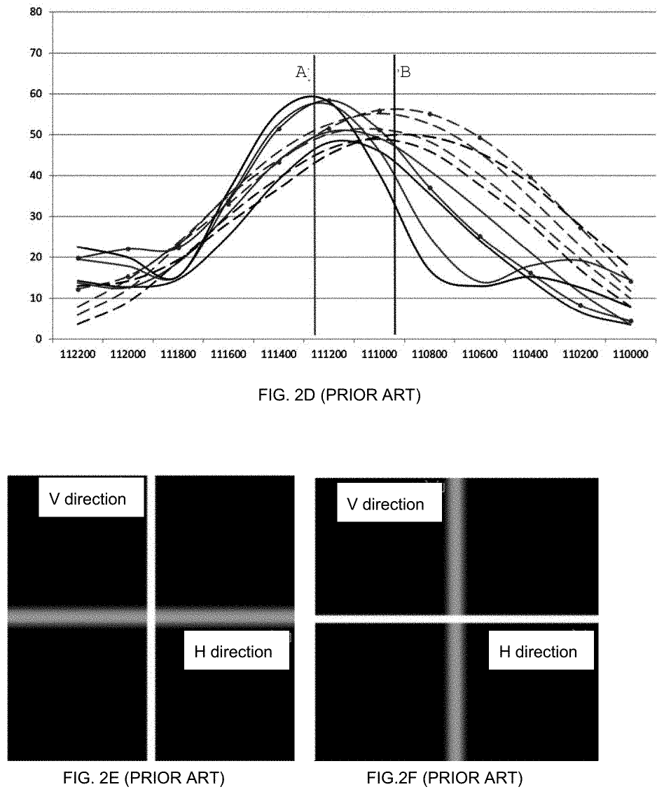

That is, the locations of peak values of the modulation transfer function in the horizontal direction and in the vertical direction appear staggered and become separated when the planar reflective surface of the prior art is replaced with the first reflective surface of the embodiments of the invention. Further, the direction in which the locations of peak values of the modulation transfer function of the invention in the horizontal direction and in the vertical direction are staggered is opposite to that in which the locations of peak values of the modulation transfer function of FIG. 2D are staggered.

As shown in the figures, when other conditions remain unchanged, the smaller the curvature of the spherical surface is, the more the locations of peak values of the modulation transfer function are staggered. Similarly, the smaller the curvature of the cylindrical surface is, the more the locations of peak values of the modulation transfer function are staggered. In other words, how much the locations of peak values of the modulation transfer function are staggered depends from how much the curvature of the spherical surface is changed. Determination of the first reflective surface to be curved inwards or outwards depends on the direction in which the locations of peak values of the modulation transfer function of the lens device are staggered, namely the direction in which the edges of the lens 102 are cut.

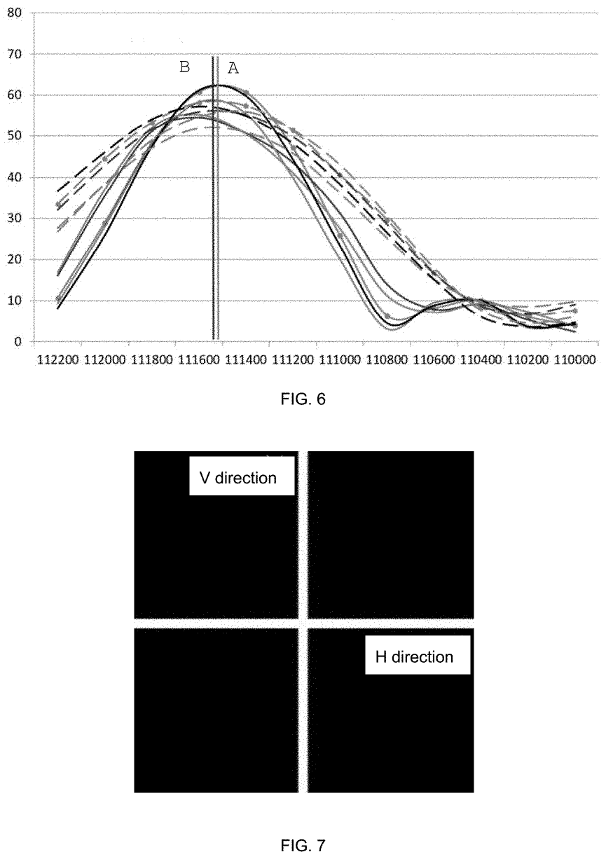

FIG. 6 is a modulation transfer function (MTF) diagram of the lens device in accordance with the invention. As shown in FIG. 6, the invention utilizes the property of the first reflective surface (i.e. capable of staggering the locations of peak values of the modulation transfer function in the horizontal direction and in the vertical direction) to compensate the staggered locations of the peak values due to cutting the edges of the lens so that the resultant locations of the peak values (indicated by points A and B) can approach to each other and even coincide.

Specifically, in order to reduce the thickness of the lens device so that the lens device can be mounted in a mini device (e.g. cell phone, tablet computer and so on) that has limited internal space, the edges of the lens are cut. However, if the edges of the lens are cut, then the peak value points A and B of the modulation transfer function of the lens in the horizontal direction and in the vertical direction will be separated from each other. Further, if the peak value points A and B in the two directions are not close to each other, then the quality of the formed image will be affected. The invention is able to address the problem. In FIG. 6, point A indicates the peak value of the modulation transfer function of the lens in the horizontal direction and point B indicates the peak value of the modulation transfer function of the lens in the vertical direction. It can be seen that the peak value points of the modulation transfer function in the two directions are rather close to each other (almost coincide). By the technical scheme of the invention, the relationship between the peak value points of the modulation transfer function of the lens device can be maintained as that of a conventional lens device (using circular lenses). In the invention, therefore, the formed image is good in quality and is clear, and miniaturization of the lens device with the thickness reduced is simultaneously achieved.

FIG. 7 is a schematic diagram showing a picture photographed by the lens device during the testing process in accordance with the invention. As shown in FIG. 7, the picture photographed by the lens device of the invention is clear in both horizontal direction and vertical direction.

When more than one reflective surface is utilized in the invention, at least one reflective surface is the above-mentioned curved surface or non-planar surface. Alternatively, a plurality of curved surfaces and non-planar surfaces are used as the reflective surfaces to perform the compensation for staggered locations of peak values of the modulation transfer function.

In conclusion, the invention utilizes at least one non-planar reflective surface (e.g. spherical surface, cylindrical surface and so on) to compensate for the staggered locations of peak values of the modulation transfer function arising from cutting the lens, so that the lens device can maintain good quality of formed images.

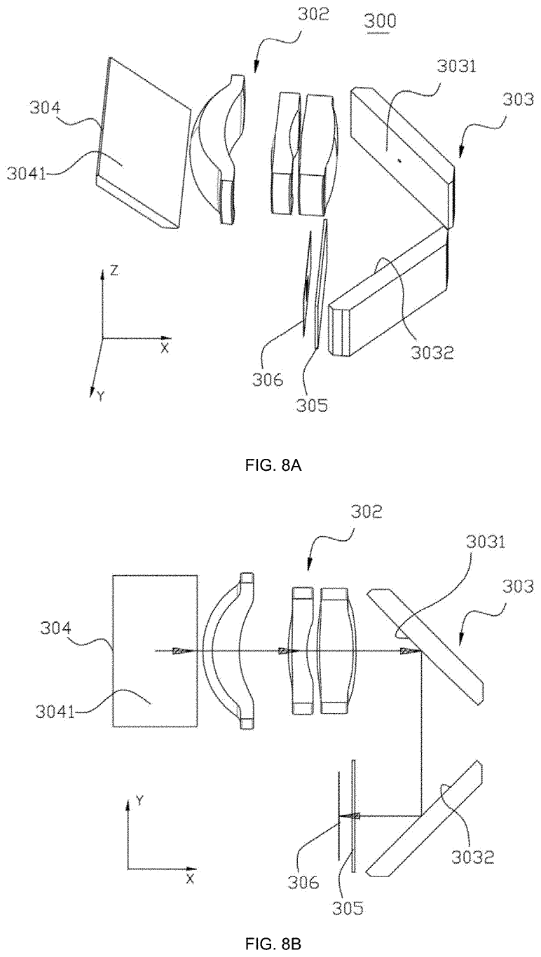

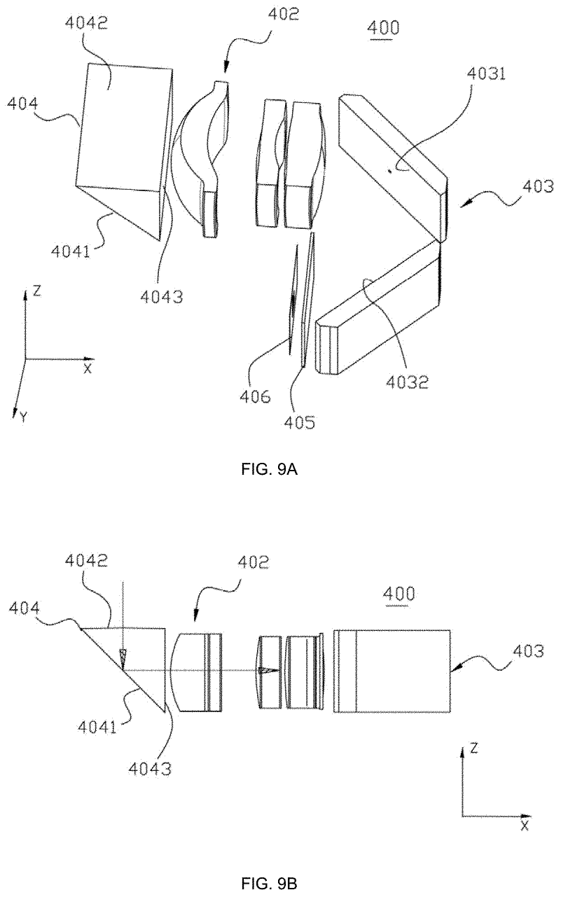

FIG. 8A is a schematic view showing the structure of a lens device 300 in accordance with a third embodiment of the invention. FIG. 8B is another schematic view showing the structure of a lens device in accordance with a third embodiment of the invention. For simplification, the part of this embodiment same as that of the first embodiment will not be described again.

In the third embodiment, the lens device 300 includes a light-path turning unit 304, a frame (not shown), one or more lenses 302 disposed in the frame, a reflective assembly 303, a light filtering unit 305 and an image forming assembly 306. The reflective assembly 303 includes a first reflective surface 3031 and a second reflective surface 3032. In operation, light passing through the lens 302 is reflected on the first reflective surface 3031 to propagate in the second direction Y, reaches the second reflective surface 3032, is reflected on the second reflective surface 3032 to propagate in the first direction X, and reaches the image forming assembly 306. Accordingly, the reflective assembly 303 provides two reflections in total.

In this embodiment, the light-path turning unit 304 is a planar reflective mirror and includes a light-path turning surface 3041. In operation, light propagates in the third direction Z, reaches the light-path turning unit 304, is reflected on the light-path turning surface 3041, propagates in the first direction X, and reaches the lens 302. The light-path turning surface 3041 is a curved reflective surface that may be a spherical surface, a cylindrical surface, a combination of part of spherical surface and part of cylindrical surface, or in other shapes. Alternatively, the light-path turning surface 3041 may include a curved surface that is inward concave or outward convex. Accordingly, the light-path turning surface 3041 of the light-path turning unit 304 may be a curved surface, and the first reflective surface 3031 and the second reflective surface 3032 of the reflective assembly 303 may be planes, to compensate for the staggered locations of the peak values of the modulation transfer function arising from cutting the lens. Further, one, two or three of the light-path turning surface 3041 of the light-path turning unit 304 and the first reflective surface 3031 and the second reflective surface 3032 of the reflective assembly 303 are curved surfaces for performing the compensation.

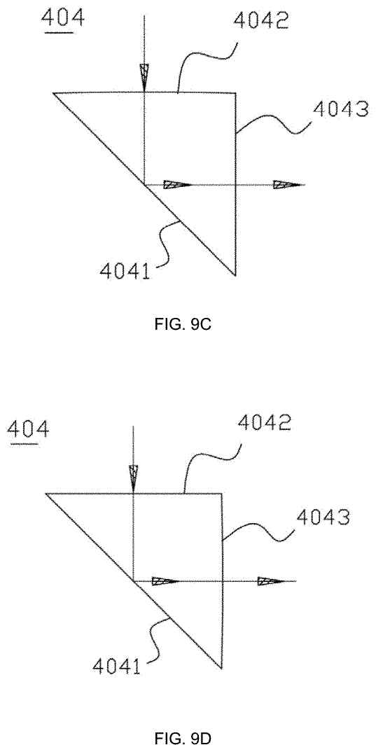

FIG. 9A is a schematic view showing the structure of a lens device 400 in accordance with a fourth embodiment of the invention. FIG. 9B is another schematic view showing the structure of a lens device 400 in accordance with the fourth embodiment of the invention. FIG. 9C is a schematic view of the light-path turning unit 404 of the lens device 400 in accordance with the fourth embodiment of the invention. The part of this embodiment same as that of the third embodiment will not be described again.

In this embodiment, the lens device 400 includes a light-path turning unit 404, a frame (not shown), one or more lenses 402 disposed in the frame, a reflective assembly 403, a light filtering unit 405 and an image forming assembly 406. The reflective assembly 403 includes a first reflective surface 4031 and a second reflective surface 4032. In operation, light passing through the lens 402 is reflected on the first reflective surface 4031 to propagate in the second direction Y, reaches the second reflective surface 4032, is reflected on the second reflective surface 4032 to propagate in the first direction X, and reaches the image forming assembly 406. In this embodiment, therefore, the light experiences three reflections in total before reaching the image forming assembly 406, wherein the light-path turning unit 404 provides one reflection and the reflective assembly 303 provides two reflections.

In this embodiment, the light-path turning unit 404 is a reflective prism and includes a light incident surface 4042, a light-path turning surface 4041, and a light emitting surface 4043. In operation, light propagates in the third direction Z, reaches the light-path turning unit 404, enters the light-path turning unit 404 through the light incident surface 4042, is reflected on the light-path turning surface 4041, propagates in the first direction X, is emitted from the light emitting surface 4043, and reaches the lens 402.

The light incident surface 4042 is a curved surface that may be a combination of part of spherical surface and part of cylindrical surface, or in other shapes. Alternatively, the light incident surface 4042 may include a curved surface that is inward concave or outward convex.

Accordingly, the light incident surface 4042 of the light-path turning unit 404 may be a curved surface, while the light-path turning surface 4041 and the first reflective surface 4031 and the second reflective surface 4032 of the reflective assembly 403 may be planes, to compensate for the staggered locations of the peak values of the modulation transfer function arising from cutting the lens. Alternatively, one (or more than one) of the light incident surface 4042 and the light-path turning surface 4041 of the light-path turning unit 404 and the first reflective surface 4031 and the second reflective surface 4032 of the reflective assembly 403 are curved surfaces for performing the compensation.

FIG. 9D is another schematic view of the light-path turning unit 400 of the lens device 400 in accordance with the fourth embodiment of the invention. FIG. 9D differs from FIG. 9C in that the light emitting surface 4043 of FIG. 9D is a curved surface that may be a spherical surface, a cylindrical surface, a combination of part of spherical surface and part of cylindrical surface, or in other shapes. Alternatively, the light emitting surface may include a curved surface that is inward concave or outward convex.

Accordingly, the light emitting surface 4043 of the light-path turning unit 404 may be a curved surface, while the light incident surface 4042 and the light-path turning surface 4041 of the light-path turning unit 404 and the first reflective surface 4031 and the second reflective surface 4032 of the reflective assembly 403 may be planes, to compensate for the staggered locations of the peak values of the modulation transfer function arising from cutting the lens. Alternatively, one (or more than one) of the light incident surface 4042, the light emitting surface 4043 and the light-path turning surface 4041 of the light-path turning unit 404 and the first reflective surface 4031 and the second reflective surface 4032 of the reflective assembly 403 are curved surfaces for performing the compensation.

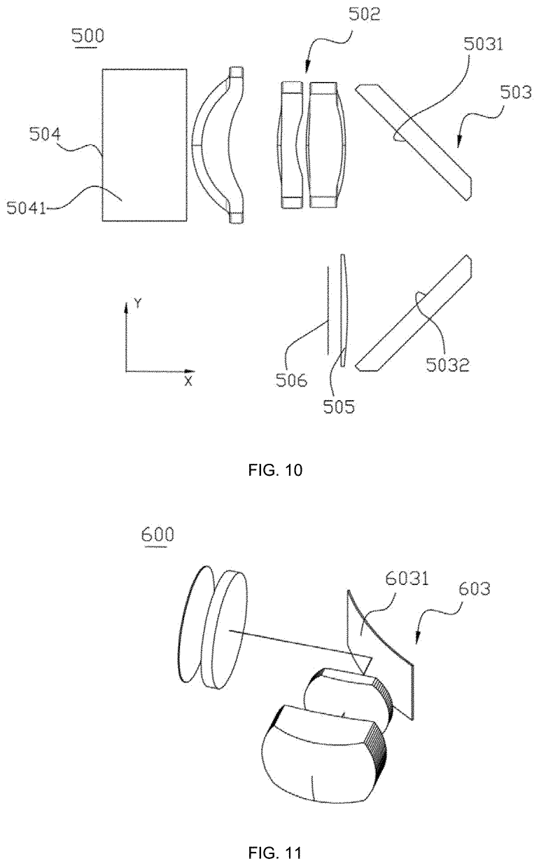

FIG. 10 is a schematic view showing the structure of a lens device 500 in accordance with a fifth embodiment of the invention. The part of this embodiment same as that of the fourth embodiment will not be described again.

In this embodiment, the lens device 500 includes a light-path turning unit 504, a frame (not shown), one or more lenses 502 disposed in the frame, a reflective assembly 503, a light filtering unit 505 and an image forming assembly 506. The reflective assembly 503 includes a first reflective surface 5031 and a second reflective surface 5032. In operation, light passing through the lens 502 is reflected on the first reflective surface 5031 to propagate in the second direction Y, reaches the second reflective surface 5032, is reflected on the second reflective surface 5032 to propagate in the first direction X, and reaches the image forming assembly 506. In this embodiment, therefore, the light experiences three reflections in total before reaching the image forming assembly 506, wherein the light-path turning unit 504 provides one reflection and the reflective assembly 503 provides two reflections.

In this embodiment, the light filtering unit 505 has at least one side surface that is a curved surface. Specifically, the side surface may be a spherical surface, a cylindrical surface, a combination of part of spherical surface and part of cylindrical surface, or in other shapes. Alternatively, the side surface may include a curved surface that is inward concave or outward convex.

Accordingly, the side surface of the light filtering unit 505 may be a curved surface, while the surfaces of the light-path turning unit 504 and the first reflective surface 5031 and the second reflective surface 5032 of the reflective assembly 503 may be planes, to compensate for the staggered locations of the peak values of the modulation transfer function arising from cutting the lens. Alternatively, one (or more than one) of the light incident surface 5042, the light emitting surface 5043 and the light-path turning surface 5041 of the light-path turning unit 504, the first reflective surface 5031 and the second reflective surface 5032 of the reflective assembly 503, and the at least one side surface of the light filtering unit 505 are curved surfaces for performing the compensation.

In each of the above embodiments, three lenses are taken as an example for descriptions. From the object side to the image side, the three lenses are respectively a concave-convex lens, a biconcave lens and a biconvex lens, and are provided with positive refractive power, negative refractive power and positive refractive power. However, the invention is not limited thereto.

FIG. 11 is a schematic view showing some elements of the lens device 600 in accordance with the sixth embodiment of the invention. The part of this embodiment same as that of the first embodiment will not be described again.

In this embodiment, the reflective assembly 603 only has the first reflective surface 6031. The second reflective surface is not included by the reflective assembly 603. It is understood that any one or two of the light-path turning unit, the first reflective surface and the second reflective surface can be selected to operate together when it is required. In other words, the lens device may only have the light-path turning unit, may only have the first reflective surface, may only have the second reflective surface, or may have at least two of the light-path turning unit, the first reflective surface and the second reflective surface. Further, the light-path turning unit, the first reflective surface and the second reflective surface can be individually disposed between the object side and the lens, between the lenses, or between the lens and the image forming assembly. The light-path turning unit and the reflective assembly may be prisms or reflective mirrors.

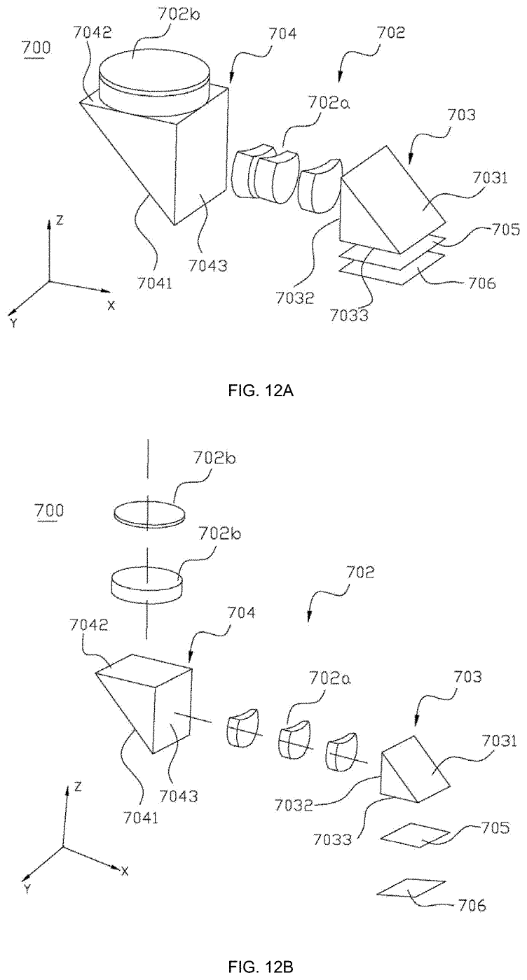

FIG. 12A is a schematic view of some elements of a lens device 700 in accordance with a seventh embodiment of the invention. FIG. 12B is a schematic view of the elements of FIG. 12A in the zooming state. The part same as or similar to that of the above embodiments will not be described again. In the seventh embodiment, the lens device 100 includes a plurality of frames and a plurality of lenses corresponding to the frames. All the frames are kept stationary, or at least one frame is stationary and the other frames are movable along the optical axis to perform zooming operation. In this embodiment, all the frames are movable along the optical axis in order to move the corresponding lenses 702 and to change the distances therebetween for the zooming operation.

The lenses 702 can be classified into two groups in accordance with the direction of arrangement. One group of lenses 702a has an optical axis extending in the first direction X. In the group, each lens 702a is formed by cutting the upper portion and lower portion of a circular lens along a plane in parallel to the first direction X and the second direction Y. The other group includes additional lenses 702b that have an optical axis extending in the third direction Z and are disposed between the object side and the lenses 702a. Each additional lens 702b may be a circular lens, may be formed by cutting both sides of a circular lens along a plane in parallel to the first direction X and the third direction Z to reduce the thickness of the lens device in the second direction Y, or may be formed by cutting both sides of a circular lens along a plane in parallel to the second direction Y and the third direction Z to reduce the thickness of the lens device in the first direction X.

The lenses 702a are movable in the first direction X in order to change the distances therebetween for the zooming operation. The additional lenses 702b are arranged in the third direction Z and connected to the light-path turning unit 704 in order to reduce the thickness of the lens device (i.e. miniaturization of the lens device) as well as to provide high-resolution optical performance. However, the invention is not limited thereto. It is still feasible that only the lenses 702a are movable, only the additional lenses 702b are movable, or both of the lenses 702a and the additional lenses 702b are movable. In a withdrawn state, the additional lenses 702b are moved close to each other so as to reduce the thickness of the lens device in the third direction Z, in case the additional lenses 702b are movable in the third direction Z to change the distance therebetween.

The lens device 700 further includes a light-path turning unit 704, a reflective assembly 703, a light filtering unit 705 and an image forming assembly 706 wherein the light-path turning unit 704 is disposed between the lenses 702a and the additional lenses 702b.

In this embodiment, the light-path turning unit 704 is a reflective prism that has a light incident surface 7042, a light-path turning surface 7041, and a light emitting surface 7043. In operation, light propagates in the third direction Z, passes through the additional lenses 702b, reaches the light-path turning unit 704, enters the light-path turning unit 704 through the light incident surface 7042, is reflected on the light-path turning surface 7041, propagates in the first direction X, is emitted from the light emitting surface 7043, and reaches the lenses 702a.

In this embodiment, the light-path turning unit 704 is a planar reflective mirror and only has a light-path turning surface 7041. In operation, light propagates in the third direction Z, passes through the additional lenses 702b, reaches the light-path turning unit 704, is reflected on the light-path turning surface 7041, propagates in the first direction X, and reaches the lenses 702a.

The lens device 700 further includes a reflective assembly 703, a light filtering unit 705 and an image forming assembly 706. In this embodiment, the reflective assembly 703 is a reflective prism that has a light incident surface 7032, a first reflective surface 7031, and a light emitting surface 7033. In operation, light coming from the lenses 702a is reflected on the first reflective surface 7031 to propagate in the third direction Z. In this embodiment, therefore, the light experiences two reflections in total before reaching the image forming assembly 706, wherein the light-path turning surface 7041 provides the first reflection and the first reflective surface 7031 provides the second reflection.

The reflective assembly 703 is not limited to the form of prism. Instead, the reflective assembly 703 may be a curved reflective mirror that has the light incident surface 7032.

In this embodiment, the reflective assembly 703 may be configured in a manner that the light coming from the lenses 702a is reflected on the reflective assembly 703 to propagate in the second direction Y. Also, it is optional that a second reflective surface is used together with the first reflective surface.

In this embodiment, at least one of the incident surface 7042 and the light-path turning surface 7041 of the light-path turning unit 704, the light emitting surface 7043 of the light-path turning unit 704, the light incident surface 7032, the first reflective surface 7031, the light emitting surface 7033 and the second reflective surface of the reflective assembly 703, and the light filtering unit 705 may be a curved surface to perform the compensation.

In the above embodiments, each of the lens devices 100, 200, 300, 400, 500, 600, 700 may further include one or more ring spacers (not shown) and a light shield (not shown). The ring spacer(s) may be disposed between the lenses to guarantee a correct distance between the lenses and to reduce the assembly error. The light shield may be disposed between the object side and the lens closest to the object side or disposed between two adjacent lenses, to control the light quantity into the lens device. It is worth noting that the ring spacer and the light shield necessarily correspond to the lenses in shape (i.e. the ring spacer is obtained from cutting away the upper portion and the lower portion of a circular ring spacer, and so is the light shield) to match an electronic device that has a limited thickness.

To sum up, for a lens device in which the lenses are cut, the invention uses optical elements having non-planar surfaces to compensate for the staggered locations of the peak values of the modulation transfer function of the lenses, wherein the optical elements can be disposed between the object side and the lenses, between the lenses, or between the lenses and the image side.

The invention uses non-planar reflective surfaces (e.g. spherical surfaces, cylindrical surfaces and so on) to compensate for the staggered locations of the peak values of the modulation transfer function arising from cutting the lenses so that the lens device can maintain good quality of the formed images.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A lens device, comprising:
at least one frame;
at least one lens disposed in the frame and having an optical axis extending in a first direction;
at least one optical element comprising at least one non-planar surface; and
an image forming assembly;
wherein light coming from an object side propagates through the lens and the non-planar surface to the image forming assembly;
wherein the lens is obtained from cutting an upper portion and a lower portion of a circular lens along planes in parallel to the first direction and a second direction.

2. The lens device as claimed in claim 1, wherein the first direction is perpendicular to the second direction, and the non-planar surface at least has a curved section when sectioned along a plane in parallel to both of the first direction and the second direction.

3. The lens device as claimed in claim 1, wherein:
the non-planar surface is a cylindrical reflective surface or a spherical surface;
the non-planar surface is bent towards or away from the lens;
a central axis of the cylindrical reflective surface is disposed at a side of the cylindrical reflective surface that is close to the lens or distant from the lens;
the central axis is extended in a third direction;
a spherical center of the spherical reflective surface is disposed at a side of the spherical reflective surface that is close to the lens or distant from the lens;
the firs direction, the second direction and the third direction are perpendicular to each other.

4. The lens device as claimed in claim 3, wherein a volume of the lens and a diameter of the cylindrical reflective surface have a positive correlation.

5. The lens device as claimed in claim 1, wherein:
the lens comprises an outer circumferential surface;
the outer circumferential surface comprises first outer circumferential portions and second outer circumferential portions;
the first outer circumferential portions are disposed opposite to each other in the second direction;
the second outer circumferential portions are connected between the first outer circumferential portions and disposed opposite to each other in a third direction;
the first direction, the second direction and the third direction are perpendicular to each other;
the frame comprises an inner circumferential surface matching the outer circumferential surface in shape;
the inner circumferential surface comprises first inner circumferential portions and second inner circumferential portions;
the first inner circumferential portions are disposed opposite to each other in the second direction;
the second inner circumferential portions are connected between the first inner circumferential portions and disposed opposite to each other in the third direction;
the first outer circumferential portions and the first inner circumferential portions are curved;
the second outer circumferential portions and the second inner circumferential portions are straight.

6. The lens device as claimed in claim 1, further comprising at least one ring spacer and light shield;
wherein the lens device comprises a plurality of lenses among which there is a lens disposed closest to an object side;
wherein the ring spacer is disposed between two adjacent lenses;
wherein the light shield is disposed between the object side and the lens disposed closest to the object side, or between two adjacent lenses;
wherein the ring spacer is obtained from cutting an upper portion and a lower portion of a circular ring spacer;
wherein the light shield is obtained from cutting an upper portion and a lower portion of a circular light shield.

7. The lens device as claimed in claim 5, wherein:
the frame further comprises third outer circumferential portions and fourth outer circumferential portions;
the third outer circumferential portions are disposed opposite to each other in the second direction;
the fourth outer circumferential portions are connected between the third outer circumferential portions and disposed opposite to each other in a third direction;
the third outer circumferential portions are provided with a plurality of strip structures.

8. The lens device as claimed in claim 7, wherein the frame further comprises a pair of concave portions and convex portions, the concave portions are disposed at an end of the frame near an object side, and the convex portions are formed next to the concave portions.

9. The lens device as claimed in claim 1, wherein the non-planar surface is curved either inwards or outwards.

10. The lens device as claimed in claim 5, wherein:
the frame defines an adhesive-applying groove;
the adhesive-applying groove is penetrated through the frame and corresponded to the second outer circumferential portions;
the adhesive-applying groove is elongated.

11. The lens device as claimed in claim 5, wherein:
the frame defines an adhesive-applying groove;
the adhesive-applying groove is penetrated through the frame and is corresponded to the second outer circumferential portions;
an outline of the second outer circumferential portion of the lens is obtained from a projection onto the frame in the third direction, and a shape of the adhesive-applying groove is similar to the outline of the second outer circumferential portion;
the adhesive-applying groove is smaller than the lens when observed in the third direction;
the frame comprises a reinforcing sheet fitting the adhesive-applying groove.

12. The lens device as claimed in claim 3, wherein:
the optical element comprises a first reflective surface and a second reflective surface;
the first reflective surface reflects the light to propagate in the second direction after the light is emitted from the lens;
the second reflective surface reflects the light along the first direction to the image forming assembly after the light is reflected on the first reflective surface;
at least one of the first reflective surface and the second reflective surface comprises the non-planar surface.

13. The lens device as claimed in claim 1, wherein:
the lens device comprises a plurality of lenses among which there are a lens disposed closest to an object side and another lens disposed closest to the image forming assembly;
the optical element is one or more following elements: a light path turning unit disposed between the object side and the lens disposed closest to the object side, a reflective assembly disposed between the object side and the lens disposed closest to the object side, a light path turning unit disposed between two adjacent lenses, a reflective assembly disposed between two adjacent lenses, and an optical filter disposed between the image forming assembly and the lens closest to the image forming assembly;
the reflective assembly comprises a first reflective surface;
the light path turning unit comprises a light path turning surface, a light incident surface and a light emitting surface;
the optical filter comprises a surface;
at least one of the first reflective surface, the light path turning surface, the light incident surface, the light emitting surface and the surface is non-planar;
the light experiences at least two reflections before reaching the image forming assembly;
the non-planar surface is configured to compensate for separation of peak values of modulation transfer function of the lens.

14. The lens device as claimed in claim 13, further comprising an additional lens fixed onto the optical element, wherein the lens device comprises one or more lenses that are stationary or movable along the optical axis.

15. The lens device as claimed in claim 2, wherein the curved section is in shape of a part of circle and the non-planar surface is a reflective surface and satisfies a condition of 4000 mm<R<5000 mm.

16. The lens device as claimed in claim 13, wherein:
the reflective assembly further comprises a first reflective part and a second reflective part;
the first reflective part comprises the first reflective surface, a first back surface disposed opposite to the first reflective surface, and plurality of first cut edges connecting the first reflective surface and the first back surface;
the second reflective part comprises a second reflective surface, a second back surface disposed opposite to the second reflective surface, and plurality of second cut edges connecting the second reflective surface and the second back surface.

17. The lens device as claimed in claim 1, wherein:
the non-planar surface is a cylindrical reflective surface or a spherical reflective surface;
for a conventional lens device that operates with the spherical reflective surface, a difference between peak values is 10 μm±5% when curvature of the spherical reflective surface is ranged from 15.5×1000 to 18.5×1000, a difference between peak values is 20 μm+5% when curvature of the spherical reflective surface is ranged from 8.5×1000 to 11.5×1000, and a difference between peak values is 30 μm+5% when curvature of the spherical reflective surface is ranged from 5.1×1000 to 8.1×1000;
for the conventional lens device that operates with the cylindrical reflective surface, a difference between peak values is 10 μm±5% when curvature of the cylindrical reflective surface is ranged from 34.5×1000 to 37.5×1000, a difference between peak values is 20 μm+5% when curvature of the cylindrical reflective surface is ranged from 18.5×1000 to 21.5×1000, and a difference between peak values is 30 μm±5% when curvature of the cylindrical reflective surface is ranged from 11.5×1000 to 14.5×1000.

18. The lens device as claimed in claim 17, wherein:
for the conventional lens device that operates with the spherical reflective surface, the difference between the peak values is 10 μm when the curvature of the spherical surface is 17000, the difference between the peak values is 20 μm when the curvature of the spherical surface is 10000, and the difference between the peak values is 30 μm when the curvature of the spherical surface is 6600;
for the conventional lens device that operates with the cylindrical reflective surface, the difference between the peak values is 10 μm when the curvature of the cylindrical surface is 36000, the difference between the peak values is 20 μm when the curvature of the cylindrical surface is 20000, and the difference between the peak values is 30 μm when the curvature of the cylindrical surface is 13000.

19. The lens device as claimed in claim 1, wherein:
the lens further comprises a first lens, a second lens and a third lens arranged from the object side to an image side;
the first lens is a concave-convex lens with positive refractive power;
the second lens is a biconcave lens negative refractive power;
the third lens is a biconvex lens with positive refractive power.

20. The lens device as claimed in claim 5, wherein the lens is a non-circular lens, the light propagates through the non-circular lens and the non-planar surface to the image forming assembly, and the non-planar surface is a cylindrical reflective surface or a spherical reflective surface.
